(19) United States
(12) Patent Application Publication
(10) Pub. No.: US 2013/0116399 A1
(43) Pub. Date: May 9, 2013

(54) METHOD FOR CARRYING OUT POLYMERISATION PROCESSES

(71) Applicants: Andreas Diener, Grosschirma (DE); Roland Kunkel, Frankfurt am Main (DE); Pierre-Alain Fleury, Ramlingsburg (CH); Bernhard Stützle, Riedisheim (FR)

(72) Inventors: Andreas Diener, Grosschirma (DE); Roland Kunkel, Frankfurt am Main (DE); Pierre-Alain Fleury, Ramlingsburg (CH); Bernhard Stützle, Riedisheim (FR)

(73) Assignee: List Holding AG, Arisdorf (CH)

(21) Appl. No.: 13/697,979

(22) PCT Filed: May 12, 2011
(86) PCT No.: PCT/EP11/02358

§ 371 Date: Jan. 22, 2013

(30) Foreign Application Priority Data
May 14, 2010 (DE) 10 2010 016 953.6
Jun. 2, 2010 (DE) 10 2010 017 218.9

(51) Int. Cl. C08G 63/88

(52) U.S. Cl. CPC C08G 63/88
USPC 528/354

(57) ABSTRACT

A method for carrying out polymerization processes, includes a first step involving polymerization or co-polymerization of a monomer or monomers, and a second step involving a separation step. In an embodiment, before the separation step, during the separation step, or both before and during the separation step, one or more substance is added to the reaction mixture that induces stripping, influencing of the temperature, or both stripping and influencing of the temperature such that the reaction equilibrium is shifted to the polymers and the rate of reaction to the monomer is slowed. In embodiments, before and/or in the second step, a substance is added to the reaction mixture so that a stop is achieved, and as a further function stripping and/or influencing of temperature occurs.

The invention relates to a method for carrying out polymerisation processes, wherein in a first step there occurs a (co)polymerisation on monomer(s) and in a second step a separation of product and monomers, oligomers, reaction products as well as additives and/or solvents.

### PRIOR ART

The prior art specifies a plurality of polymerisation processes, for example, for methyl methacrylate (MMA) or polymethyl methacrylate (PMMA). Specific reference is being made therein to WO 2004/072131, DE 10 2005 001 802 A1 or EP 1 590 075 A1. The same are only of an exemplary nature.

The present invention, in particular, also refers to polylactide (PLA), however, also if only by way of an example. PLA will be a polymer of great interest in the future, because it is manufactured of NON-oil-based raw materials, while still principally being able to achieve the properties of polyester (PET). Experiments conducted to date have demonstrated that the polymerisation works very well, while finishing, due to the equilibrium reaction (depolymerisation), is still awaiting an optimal solution. Moreover, existing technologies struggle with discolorations due to temperature.

Task

The object of the present invention seeks to develop a preferably two-step method of the type as described above in which the polymerisation, and particularly devolatilization or finishing, are conducted in an overall optimal manner.

Solution

The object is achieved if prior to and/or in the second step, meaning during finishing, a substance is added to the reaction mixture that will induce stripping and/or temperature-related influencing by which the reaction equilibrium is shifted toward the polymers, wherein the rate of reaction to the monomer is slowed down.

A further embodiment according to the invention, for which protection is sought separately but, first and foremost, in connection with the first embodiment, provides that before and/or in the second step, meaning during finishing, a substance is added to the reaction mixture that causes a stop and stripping and/or temperature-related influencing as a second function.

Today, new information is available regarding substances primarily from the finishing of temperature-sensitive natural rubbers acting in the way of a turbo, whereby the degassing time is drastically reduced and the residual solvent content can be simultaneously extremely lowered.

It is important to use a chemically reactive stopper that acts at the same time as an evaporation cooling agent and as a stripper that can, however, remain behind in minimal concentrations in the PLA, that is cheap, known to operators and approved for use in food products (FDA approval from other comparable applications).

PLA polymerisation is an equilibrium reaction that can, using the technology according to the Invention, achieve marvelous yields of 90% to 100%, typically 91% to 95%, for example 93% (existing technologies stop the reaction at yields of 50 to 80%). To obtain the residual monomers (lactides) with the required 2000 ppm or below 2000 ppm for the application, it is necessary to add a finishing step. To date, demonomerization (finishing) has been based on an in as far as possible deep vacuum (1 mbar (abs)); nevertheless, the required 2000 ppm were not obtained at all or only with difficulty.

The basic idea of the present invention envisions that, due to the equilibrium reaction between the polymer and monomer, a chemical stopper, a so-called “end capper,” is to be used before finishing. These “end cappers” are high-molecular alcohols that serve, simultaneously, for the functionalization.

The task consists in finding an end capper that is able to meet the objectives as defined in the task. Following a review of the literature and comparison of technologies as well as based on the product properties of polyester (PET), glycol was found to be a chemical with an interesting boiling range, which is available as mono-, di- and triethylene glycol, and whereby it can be used for functionalization. Due to the boiling range of 157° C. at 250 mbar, 177° C. at 500 mbar and 193° C. at atmospheric pressure, ethylene glycol is perfectly suited for maintaining a product temperature of ca. 190° C. (+/−10K) during finishing. Other higher-valent alcohols C₆ to C₁₀ are conceivable as well, such as intend, for example.

Due to the low steam pressure of the monomer (lactides), in addition to the process pressure, a very low lactide partial pressure must also be present in order to provide a sufficient driving gradient for degassing. Tests with the necessary analytical parameter correlations must be carried out for this purpose. it is known from the experiences with natural rubber that ca. 0.2 to 0.3 kg stripping agent/kg of final polymer are needed.

Based on the experiences with natural rubber it is also known that minimal quantities of the stripping agent are left behind in the polymer. This is why the residual content of ethylene glycol in PET was researched in the literature. The normal DEG content in PET is at 2% (wt). For high-grade PET, the value is still 0.6% (6000 ppm). The desired monomer content in PLA is below 2,000 ppm lactide, preferably below 1,500 ppm or even 1,000 ppm. Due to the fact that these values are visibly below the preset values as well as the effective PET values, this technology according to the invention offers a very interesting solution.

An issue remaining open to be clarified and/or better understood by means of experimentation is only the relationship between the product temperature, the necessary vacuum and the lactide and/or glycol content obtained therein.

To be viewed as a great advantage that is offered by this technology in contrast to the technology that is currently in use, is the exact control of the temperature at a very low level, whereby the equilibrium reaction is shifted in the direction of the polymer, and whereby degradation and thus discoloration can be minimized or even prevented altogether. With the lower temperature it is possible, using less catalyst, to generate more stable PLA having long chains, meaning a qualitatively higher-grade product.

1.-22. (canceled)

23. A method for carrying out polymerization processes, including:
a first step involving polymerization or copolymerization of a monomer or monomers; and
a second step involving a separation step;
wherein before the separation step, during the separation step, or both before and during the separation step, one or more substance is added to the reaction mixture that induces stripping, influencing of the temperature, or both stripping and influencing of the temperature, whereby the reaction equilibrium is shifted to the polymers and the rate of reaction to the monomer is slowed.

24. The method of claim 23, wherein the separation step includes separation of product and monomers, oligomers, reaction products, additives, and solvents.

25. The method of claim 23, wherein in a first step there occurs a (co)polymerisation of monomer(s) and in a second step a separation of product and monomers, oligomers, reaction products as well as additives and/or solvents, characterized in that before and/or in the second step, meaning during finishing, a substance is added to the reaction mixture that induces a stop and by way of a second function stripping and/or influencing of the temperature.

26. The method of claim 23, wherein, due to the addition of one or more substance, the equilibrium of the reaction is shifted toward the polymers, the rate of reaction to monomers is slowed down/frozen, or the reaction is shifted toward the polymers and the rate of reaction to monomers is slowed down/frozen.

27. The method of claim 23, wherein the stopping of the first step or the removal of excess monomer by means of a stripping agent occurs using the same one or more substance.

28. The method of claim 23, wherein the one or more substance is used for removing the monomer and strips the monomer from the process by lowering the partial pressure, wherein the partial pressure of the monomer at the present temperature is below the boiling point of the monomer.

29. The method of claim 23, wherein the one or more substance is used for removing the monomer and serves as a transport agent for the monomer from a finisher.

30. The method of claim 23, wherein the one or more substance is used for removing the monomer and evaporates with the process conditions on the surface of the reaction mixture, thereby having the effect of an evaporative cooling medium.:

31. The method of claim 23, wherein the one or more substance comprises a high-molecular alcohol or a derivatives thereof.

32. The method of claim 31, wherein the one or more substance comprises octanol, isopentanol, cyclohexanol, ethylene glycol, or isoamyl alcohol.

33. The method of claim 23, wherein one or more substance is used for removing the monomer and is added as a liquid to a finisher in one or several places, and the added quantity distributes itself in several places over the length of the finisher.

34. The method of claim 23, wherein the one or more substance is used for removing the monomer and partially remains in the polymer at a concentration of 0.01 to 10%, and functions as a stopper.

35. The method of claim 23, wherein the one or more substance is used for removing the monomer and partially remains in the polymer at a concentration of 0.2 to 2%, and functions as a stopper.

36. The method of claim 23, wherein the one or more substance is used for removing the monomer and partially remains in the polymer at a concentration of 0.01 to 10%, and acts as a functionalizer.

37. The method of claim 23, wherein the one or more substance is used for removing the monomer and partially remains in the polymer at a concentration of 0.2 to 2%, and acts as a functionalizer.

38. A method for carrying out polymerization processes, including:
a first step involving polymerization or co-polymerization of a monomer or monomers; and
a second step involving a separation step;
wherein before the separation step, during the separation step, or both before and during the separation step, one or more substance is added to the reaction mixture that induces stripping, influencing of the temperature, or both stripping and influencing of the temperature, whereby the reaction equilibrium is shifted to the polymers and the rate of reaction to the monomer is slowed;
and wherein the one or more substance is used for removing the monomer and serves as a transport agent for the monomer from a finisher, and the polymer temperature in the finisher is held constant by the added quantity of the substance in a temperature range between 175° and 225° C.

39. The method of claim 38, wherein the polymer temperature in the finisher is held constant by the added quantity of the substance in a temperature range between 180° and 195° C.

40. The method of claim 38, wherein a mixture of monomer and stripping medium escapes from the finisher as a vapor flow, and a separation of the monomer from the stripping agent occurs because of different boiling points or precipitation of the monomer in the stripping agent.

41. The method of claim 40, wherein a purified stripping agent can be reused in the second step.

42. A method for carrying out polymerization, processes, including:
a first step involving polymerization or co-polymerization of a monomer or monomers; and
a second step involving a separation step;
wherein before the separation step, during the separation step, or both before and during the separation step, one or more substance is added to the reaction mixture that induces stripping, influencing of the temperature, or both stripping and influencing of the temperature, whereby the reaction equilibrium is shifted to the polymers and the rate of reaction to the monomer is slowed; and the polymerization is stopped and the monomer removed in a degassing kneader having one or multiple shafts and using the same substance.

43. The method of claim 42, wherein that in kneaders having a plurality of shafts the same can rotate in different or in the same directions of rotation, but also at different and same speed ratios.

44. The method of claim 42, wherein the kneaders are continuously operated.

45. The method of claim 42, wherein the kneaders realize an intensive surface renewal.

46. The method of claim 42, wherein the kneader is operated at a process pressure of 1 to 2000 mbar absolute.

47. The method of claim 42, wherein the kneader is operated at a process pressure of 5 to 500 mbar absolute.

48. The method of claim 42, wherein the one or more substance is added at a ratio from 0.1:1 to 1:1 to the polymer in a finisher.

49. The method of claim 42, wherein the one or more substance is added over the length to the degassing kneader.
